(19) United States
(12) Patent Application Publication
(10) Pub. No.: US 2006/0261979 A1
(43) Pub. Date: Nov. 23, 2006

(54) Event detection system

(75) Inventors: Maurice Herman Johan Draaijer, Eindhoven (NL); Paulus Henricus Antonius Damink, Eindhoven (NL); Maurice Leonardus Anna Stassen, Eindhoven (NL); Sel Brian Colak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/555,398

(22) PCT Filed: May 5, 2004
(86) PCT No.: PCT/IB04/50586

§ 371 Date: Nov. 2, 2005

(30) Foreign Application Priority Data
May 7, 2003 (EP) 03101260.2

(51) Int. Cl. G08G 1/054

(52) U.S. Cl. 340/937

(57) ABSTRACT

An event detection system (100) comprises: a communication network of interconnected nodes (10) and a central control station (200), each node being capable of communicating to at least one adjacent node and/or to the central control station, each node comprising: at least one microphone (11); a GPS receiver (12, 13) providing information regarding its location and providing time information; a processing circuit (17), capable of processing the microphone signals, the processing circuit being designed to detect the occurrence of predetermined characteristic sound patterns, and if the occurrence of a predetermined characteristic sound pattern is detected, to communicate the detected event to the central station, together with information regarding location of the node and time of detection; wherein the central station is designed to process the information received from the nodes and to determine the location of the audio source and the occurrence time of the event.

The present invention relates in general to an event detection system.

In the context of the present invention, events to be detected are events such as car accidents, airplanes flying over at low altitude, a burglar breaking into a home, etc. It is desirable to detect the occurrence of such events, and to take appropriate action in response. For instance, in residential areas, low-flying airplanes may be dangerous and hence forbidden, and the accompanying noise may be annoying to people, who wish to complain, but it is very difficult for such people to determine the exact altitude and trajectory of the plane. In case of breaking and entry, it is very desirable to respond immediately. In case of a car accident, it is desirable to direct emergency personnel to the accident location as quickly as possible, and to arrange for the traffic to be directed away from the accident location. Important minutes may go by in case the officials wait until a bystander calls for emergency assistance by telephone. Further, in the aftermath of a car accident, legal issues may arise: how fast did the car(s) drive, did the parties use their brakes, etc. The answers to these questions may have influence on the question of who is responsible and has to pay the damages.

Thus, an important objective of the present invention is to provide an event detection system capable of reliably detecting not only the occurrence of such events, but also the event location, and time of occurrence.

According to an important aspect of the present invention, an event detection system comprises a communication network of interconnected nodes, each node being capable of communicating to at least one adjacent node and/or to a central control station. Each node comprises at least one microphone arranged outdoors, or at least arranged such that outdoor sound can freely reach the microphone. Each node further has information regarding its location; in a preferred embodiment, each node comprises a GPS receiver receiving signals from the satellites of the well-known GPS system, providing position information. Further, all nodes are associated with accurately synchronised clock means; in a preferred embodiment, each node comprises a GPS receiver receiving signals from the satellites of the well-known GPS system, providing accurate time information.

The nodes are preferably arranged in an array at mutual distances in the order of 10-100 m. In a very suitable embodiment, the nodes are associated with street lighting armatures or lamp posts, of which the mutual distance in practice typically is in the order of about 30 m. Communication between nodes may occur by any suitable means, wired or wireless, for instance by telephone but preferably communication takes place over optical links.

Each node comprises a sound processing circuit, capable of processing the output signals of the corresponding microphone, and designed to detect the occurrence of predetermined characteristic sound patterns. For instance, a car collision produces sound with a very characteristic sound, which, with suitable sound processing, can easily be distinguished from normal traffic noise. Likewise, the screeching noise of a car with blocked wheels desperately trying to make an emergency stop can easily be distinguished from normal traffic noise. Even the explosion of an air bag produces sound with a very characteristic sound, which can easily be distinguished from normal traffic noise. Likewise, the sound of breaking glass can easily be distinguished.

A first part of sound processing is executed by the sound processing circuits of the nodes. Thus, each node is capable of determining whether one or more of predetermined events occur in its surroundings, or better: within its sound detection field. If so, the event detected is communicated to the central station, together with information regarding location of the node and time of detection.

The central location receives input from a plurality of nodes, the number depending on the loudness of the sound. By comparing the timing information contained in its input signals, the central location is capable of determining quite accurately the location of the audio source, its direction of travel, etc. Further, the central location is capable of determining quite accurately the occurrence time of the event.

In a preferred embodiment, each node comprises a buffer for storing a predetermined amount of input signal, for instance 30 seconds of ambient sound. Then it is possible, if an event occurs, to store the sound of the period immediately before the event, for later analysis.

These and other aspects, features and advantages of the present invention will be further explained by the following description with reference to the drawings, in which same reference numerals indicate same or similar parts, and in which:

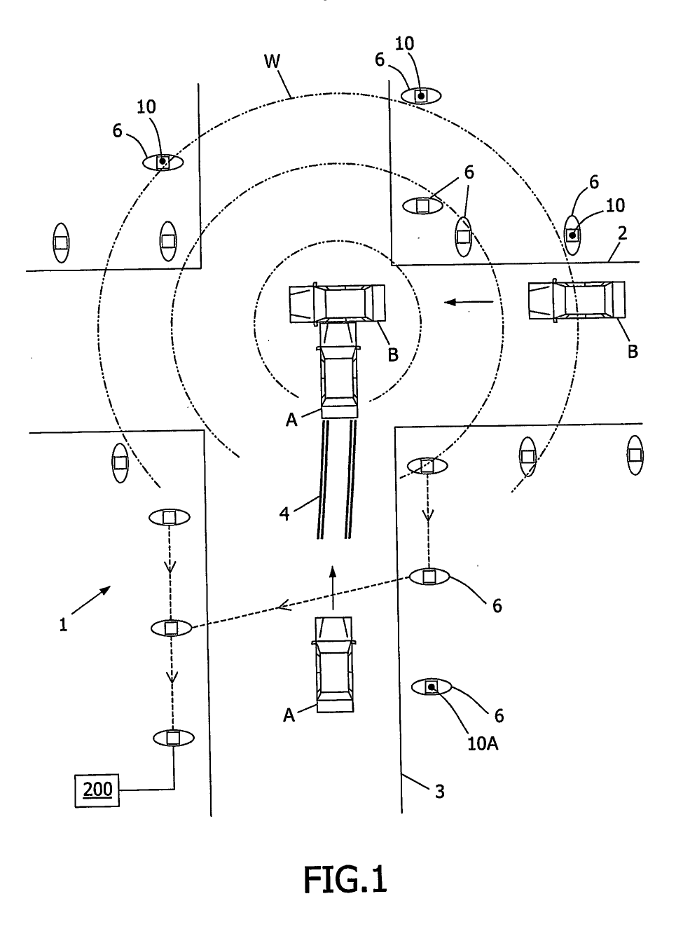

FIG. 1 schematically shows a top view of a traffic situation at a street crossing;

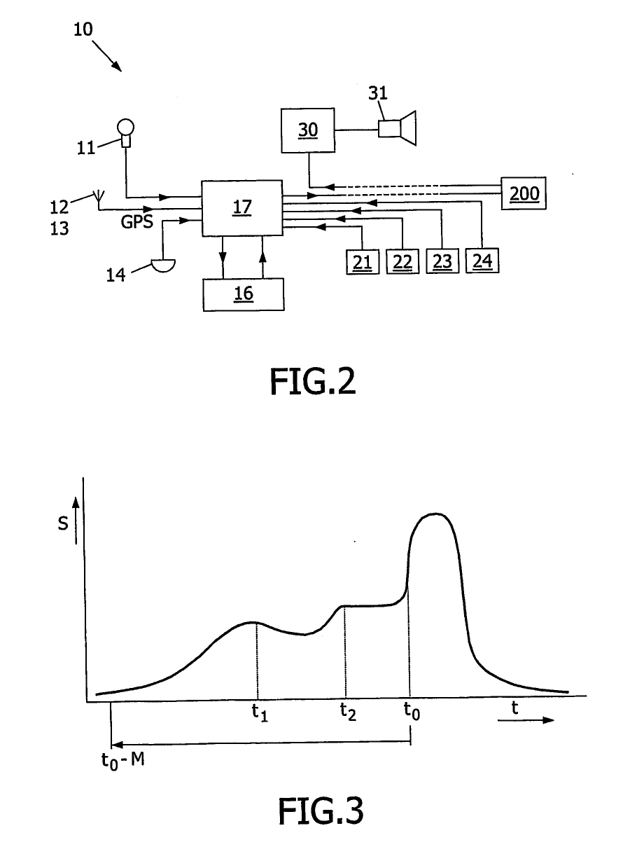

FIG. 2 is a block diagram schematically illustrating elements of a node;

FIG. 3 is a graph schematically illustrating sound picked up by a node.

FIG. 1 schematically shows a top view of a street crossing 1, where a side street 2 crosses a main street 3. The streets 2, 3 are provided with street lighting armatures 6, mounted on lighting poles not shown for the sake of clarity. Each lighting armatures 6 is provided with a node 10 of an event detection system 100 according to the present invention. These nodes 10 cooperate to process and recognize the outdoor sound. As shown in FIG. 2, each node 10 comprises a microphone 11, which is mounted such that it can receive outdoor sound. Each node 2 further comprises a sound processing circuit 17, having an input coupled to receive the output signal of the microphone 11. The sound processing circuit 17 is capable of processing the output signals of the corresponding microphone 11; more particularly the sound processing circuit is designed to detect the occurrence of predetermined characteristic sound patterns.

The event detection system 100 further comprises a central station 200 which, in the embodiment as shown in FIG. 1, is associated with one of the nodes 10. All nodes are capable of communicating with this central station 200, either directly or indirectly, through other nodes.

Each node further comprises a signal buffer 16, having an architecture of a shift memory (first in first out), and having a capacity to store the equivalent of about 30 sec of the signal of the microphone 11. It should be clear that the size of the signal buffer 16 may be larger or smaller than 30 sec.

Each node 10 further comprises location means 12 arranged for providing information regarding the location of the node 10. This location means 12 may be a simple memory, in which the location coordinates are stored by the manufacturer, or by personnel on mounting the node 10 in place. Preferably, however, the location means 12 comprises a GPS receiver, as indicated, receiving GPS signals from the satellites of the OPS system. Since the GPS system is well-known to a person skilled in the art, it is not necessary here to explain this system in more detail; suffice it to recall that the GPS signals allow a suitable designed receiver to calculate the coordinates of its location.

Each node 10 further comprises clock means 13 arranged for providing information regarding the date and the local time of days. This clock means 13 may, in principle, be any common clock signal generator, having sufficient accuracy, but the clock signals of all clock means of all nodes should be synchronised. Preferably, the clock means 13 comprise a clock receiver, receiving a common clock signal, for instance generated by the central station 200. In a most preferred embodiment, the clock means 13 comprises a GPS receiver, as indicated, receiving GPS signals from the satellites of the GPS system. Since the GPS system is well-known to a person skilled in the art, it is not necessary here to explain this system in more detail; suffice it to recall that the GPS contains accurate timing information.

A first car A travels on the main street 3; a second car B approaches on the side street 2. When A sees B, he tries to break, causing break marks 4 with his wheels being blocked, but it is too late: a collision occurs. The collision causes sound waves, indicated at W, which sound waves are picked up by the microphones 11 of the nodes 10. The sound caused by a collision has a very characteristic sound pattern, which is recognized by the sound processing circuits 17 of the nodes 10, so that the sound processing circuits 17 decide that an event “collision” has occurred.

In response to detecting the occurrence of a collision (or other event), each sound processing circuit 17 is programmed to notify this event to the central station 200. In its communication to the central station 200, the sound processing circuit 17 includes information regarding the location of the corresponding node 10, and information regarding the time of occurrence of the event. In this respect it is noted that each node may have received a unique identification number (ID); if the central station 200 comprises a memory (for instance a table) relating the node IDs to their respective locations, the sound processing circuit 17 may simply communicate its ID to the central station 200, and the location means 12 may merely comprise a small memory containing the node ID.

As should be clear to a person skilled in the art, the nodes closer to the place of the collision receive the characteristic sound pattern earlier than nodes located farther away. Thus, by comparing location and time information contained in the incoming signals from the nodes, the central station 200 is capable to calculate the exact time and location of the event.

In such calculation, the central station 200 will take into account the propagation speed of sound waves in air (sound speed). Thus, propagation time of a sound wave corresponds to length of propagation path. In a first approximation, it may be assumed that the sound speed has the same value at all locations and in all directions, this value being a known value (about 300 m/s). Then, the sound waves W will have circular shapes centred at the event location, as illustrated in FIG. 1. Calculating a point of origin of the sound is relatively easy then, as will be appreciated by a person skilled in the art. However, in practice it may turn out that the sound speed is not as homogeneously distributed over a wide area. Propagation speed may be influenced by wind speed, which can be visualised as a deformation of the shape of the sound waves. Also, objects such as buildings may force sound waves to take a detour, also effectively causing deformations of the sound waves. Such effects may affect the accuracy with which the central station 200 is capable of calculating the event location.

In a preferred embodiment, the event detection system of the present invention is capable of compensating for these effects. More particularly, the system may be provided with measuring means capable of generating signals to the central station 200 indicating sound speed.

In one embodiment, one or more of the nodes 10, preferably all nodes, comprise a wind sensor 22, i.e. a sensor capable of generating a signal indicative of wind direction and wind speed. Since such wind sensors are known per se, it is not necessary here to explain its design and functioning in more detail.

The nodes 10 may be designed to regularly or even constantly send wind speed and wind direction information to the central station 200. However, this is not necessary. Usually, it suffices if a node, when detecting an event and notifying this to the central station 200, also includes wind speed and wind direction information.

It should be clear to a person skilled in the art that the central station 200, when having information regarding wind speed and wind direction at a large number of locations, preferably corresponding to the locations of the nodes, is capable to take this information into account when calculating the location of the event.

It is noted that the system may also, additionally or alternatively, comprise one or more wind sensors not mounted to a node, yet capable of communicating wind information to the central station 200, for instance via a node.

In another embodiment, one or more of the nodes 10, preferably all nodes, comprise a loudspeaker 31 capable of generating a pilot tone. On receiving a certain instruction from the central station 200, a speaker controller 30 of a node may drive the corresponding loudspeaker 31 to emit a sound having a predetermined duration and spectrum (for instance, having substantially only one predetermined tone or combination of tones). This sound will be picked up by the microphones 11 of surrounding nodes, who will communicate this fact to the central station 200, together with the time of receipt. It is also possible that such speaker controllers 30, more or less autonomously, drive the corresponding loudspeaker 31 to emit the pilot sound, coded such as to contain time and location (node ID) of transmission. In both cases, the central station 200 will have at its disposal information regarding time and location of transmission and information regarding time and location of receipt, so for each combination of transmitting node A and receiving node B, the central station 200 is capable to calculate the propagation time, i.e. the time needed for a signal to travel from A to B. Especially if the central station 200 also receives information allowing it to calculate the time needed for a signal to travel from B to A, the central station 200 is capable of calculating wind speed between A and B. Based on such propagation time measurements and/or wind speed measurements, the central station 200 can more accurately calculate event location, as should be appreciated by a person skilled in the art.

It is noted that the system may also, additionally or alternatively, comprise one or more pilot tone generators not mounted to a node, yet capable of communicating to the central station 200, for instance via a node.

FIG. 3 is a graph schematically illustrating, by way of example, the sound pattern S (vertical axis) received by a node 10A as a function of time (horizontal axis). At time t0, the sound processing circuit 17 of this node detects the characteristic sound pattern of a car collision. The time interval from t0-M to t0 corresponds to the signals currently present in the signal buffer 16. These signals may represent the car A passing node 10A at time t1, and starting to brake at time t2. In the preferred embodiment where the nodes 10 are provided with a signal buffer 16 as mentioned, each sound processing circuit 17 is programmed, in response to detecting the occurrence of a collision (or other event), to also communicate to the central station 200 the contents of its signal buffer 16. Using the contents of the signal buffers of several nodes, the central station 200 is capable, for instance, to calculate when and where the cars started to brake, an to calculate how fast each car was driving immediately before the drivers hit the brake.

The central station 200 may be programmed to passively wait for the nodes 10 to send data. Preferably, however, the central station 200 is capable to send commands to individual nodes, causing such nodes to communicate to the central station 200 the contents of their signal buffers 16. So, even if a node has not detected an event, the contents of the signal buffer 16 of such node may be used by the central station 200. Thus, depending on the size of the signal buffer 16, it is possible to track the car A further back in history as regards its location, hence its speed.

Immediately after the event has occurred, the central station 200 is aware of this, and also the central station 200 knows the location of the event and the nature of the event. The central station 200 may be designed to take action, such as by sending a call to rescue services, police, etc.

In a preferred embodiment, one ore more of the nodes, preferably each node 10, is also provided with a video camera 14, capable of taking video pictures from the scene in its surroundings, in which case the processing circuit 17 may be programmed to send to video signals to the central station 200. The video camera 14 may be constantly active, but it is also possible that the video camera 14 is only activated by the central station 200 as action in response to detecting an event. Thus, it is assured that only those cameras in the vicinity of an event location are operative.

With such camera pictures at their disposal, control personnel is capable to quickly assess the situation and, if necessary, to take further action. It is also possible that the central station 200 has video processing capabilities, for automated situation assessment and action. Further action may involve controlling traffic lights. For instance, in the situation depicted in FIG. 1, assume that the crossing is provided with traffic lights: in order to prevent a traffic chaos, the central station 200 may set all traffic light to red, except the lights for the road where rescue services are expected to approach the scene, so that traffic is allowed to evacuate the road for the rescue services and allow them free access. Such action may be automatic, but may also be taken by surveillance personnel.

On the other hand, in preferred embodiments where nodes comprise video cameras, such cameras may be constantly operative. The processing device 17 may be provided with image processing software in order to detect the occurrence of events, such as speeding, ignoring red traffic lights, or possible criminal activity. If such events are detected, the central station 200 is notified, and one or more video images are sent to the central station 200, where they are stored as evidence. It is noted that conventional traffic cameras need photographic films, which need to be entered into the camera, taken away after some time, developed, etc.

Image processing software also allows a processing device 17 to “read” registration plates. The central station 200 may issue a communication to all nodes 10 that a certain car having a certain registration plate has been stolen. Each processing device 17 stores this information in an accompanying memory. The processing device 17 processes the images from the camera 14, recognizes a car, recognizes the registration plate of the car, and recognizes the registration number of the registration plate. The processing device 17 compares this registration number with the information in its memory. In case of a match, the processing device 17 determines that an event is taking place, i.e. a stolen car is passing, and sends a communication to the central station 200. The image processing software of the processing device 17 allows the speed and direction of the stolen car to be determined. Adjacent nodes may be “warned” to be extra alert for this registration number, so that detection by adjacent nodes is accelerated.

Preferably, one or more of the nodes 10, more preferably each node 10, further comprises a weather detector and/or a seismic detector 24. For instance, a weather detector may comprise a temperature sensor 21, a wind sensor 22, a rain sensor 23, etc.

The readings from sensors 21, 22, 23 may be continuously or regularly communicated to the central station 200, so that the system as a whole constitutes a fine-mazed weather station, which may also include barometric sensors, humidity sensors, etc. The processing circuit 17 may also be designed to monitor the weather sensors 21, 22, 23 for events which may have an influence on traffic safety, such as heavy rain, heavy wind, freezing cold temperatures, etc. If such events are detected, the processing circuit 17 may communicate such to the central station 200, which may arrange for a public warning to be issued, for instance over the radio, so that car drivers may hear this warning on their car radio. It is also possible that cars are equipped with communication devices allowing them to communicate directly with the nodes 10, in which case the nodes may send the weather information to a car directly. In response, a control device onboard of such car may automatically switch ON or OFF apparatus like heating equipment, airconditioning equipment, windscreen wipers, etc.

Conversely, modern cars may have one or more weather sensors, for instance a rain sensor, a temperature sensor, etc. Cars may be equipped with communication devices allowing them to communicate directly with the nodes 10, in which case the cars may communicate the readings of their weather sensors to the nodes.

It should be clear to a person skilled in the art that the present invention is not limited to the exemplary embodiments discussed above, but that several variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Event detection system (100), comprising: a communication network of interconnected and cooperating nodes (10) and a central control station (200), each node being capable of communicating to at least one adjacent node and/or to the central control station, each node comprising:
at least one microphone (11) arranged for receiving outdoor sound;
location means (12) providing information regarding its location;
clock means (13) providing time information;
a processing circuit (17), capable of processing the output signals of the corresponding microphone (11), the processing circuit (17) being designed to detect the occurrence of predetermined characteristic sound patterns, and if the occurrence of a predetermined characteristic sound pattern is detected, to communicate the detected event to the central station (200), together with information regarding location of the node and time of detection;
wherein the clock means (13) of all nodes are accurately synchronised;
and wherein the central station (200) is designed to process the information received from a plurality of nodes and to determine the location of the event and the occurrence time of the event.

2. System according to claim 1, wherein each node comprises a GPS receiver (12, 13) receiving GPS signals, containing accurate position information and accurate time information.

3. System according to claim 1, wherein the central station (200) is designed, when calculating the location of the event, to take into account the propagation speed of sound waves.

4. System according to claim 3, wherein the propagation speed of sound waves is taken to be constant.

5. System according to claim 3, wherein the central station (200) is designed to compensate for deviations of propagation speed.

6. System according to claim 5, further comprising at least one wind sensor (22) capable of generating a signal indicative of wind direction and wind speed.

7. System according to claim 5, further comprising at least one loudspeaker (31) capable of generating a pilot tone.

8. System according to claim 1, wherein the nodes are arranged in an array at mutual distances in the order of 10-100 m.

9. System according to claim 1, wherein the nodes are associated with street lighting armatures (6) or lamp posts.

10. System according to claim 1, wherein the nodes are designed for communication over optical links.

11. System according to claim 1, wherein each node comprises a buffer (16) having a size sufficient for storing a predetermined amount of input signal, for instance corresponding to 30 seconds of sound.

12. System according to claim 1, wherein each node further comprises a video camera (14).

13. System according to claim 12, wherein the video camera (14) of a node (10) is activated by the central station (200) in response to detecting an event.

14. System according to claim 12, wherein the processing device (17) is provided with image processing software.

15. System according to claim 14, wherein the image processing software is capable to recognize events such as, for example, speeding, ignoring red traffic lights, or possible criminal activity.

16. System according to claim 14, wherein the image processing software is capable to read registration plates.

17. System according to claim 15 or 16, wherein the processing device (17) is designed to send one or more video images to the central station (200).

18. System according to claim 16, wherein the central station (200) is designed to communicate wanted registration numbers to the nodes (10), and wherein the processing devices (17) are designed to compare a registration number of a camera image with the wanted registration numbers.

19. System according to claim 1, the nodes (10) further comprising at least one sensor from the group comprising a temperature sensor (21), a wind sensor (22), a rain sensor (23), a seismic detector (24), a barometric sensor, a humidity sensor.

20. System according to claim 19, wherein the processing circuit (17) is designed to monitor the said sensors for events which may have an influence on traffic safety, and to communicate such event to the central station.

21. System according to claim 1, wherein the nodes are adapted for communication with individual cars.

22. System according to claim 21, wherein the nodes are designed to communicate weather information to the passing cars.

23. Vehicle, adapted for communication with a node of a system of claim 1.

24. Vehicle, adapted for communication with a node of a system (100), comprising:
a communication network of interconnected and cooperating nodes (10) and a central control station (200), each node being capable of communicating to at least one adjacent node and/or to the central control station, each node comprising:
at least one microphone (11) arranged for receiving outdoor sound;
location means (12) providing information regarding its location;
clock means (13) providing time information;
a processing circuit (17), capable of processing the output signals of the corresponding microphone (11), the processing circuit (17) being designed to detect the occurrence of predetermined characteristic sound patterns, and if the occurrence of a predetermined characteristic sound pattern is detected, to communicate the detected event to the central station (200), together with information regarding location of the node and time of detection;
wherein the clock means (13) of all nodes are accurately synchronised;
and wherein the central station (200) is designed to process the information received from a plurality of nodes and to determine the location of the event and the occurrence time of the event, comprising a control device adapted to automatically switch ON or OFF apparatus like heating equipment, airconditioning equipment, windscreen wipers, etc. in response to receiving weather information from a node of a system of claim 17.

25. Vehicle according to claim 23, comprising one or more weather sensors, adapted to communicate readings of its weather sensors to a node (10).
